(19) United States
(12) Patent Application Publication
(10) Pub. No.: US 2007/0296673 A1
(43) Pub. Date: Dec. 27, 2007

(54) LIQUID CRYSTAL DISPLAY DEVICE AND DRIVING METHOD THEREOF

(75) Inventors: Nam Soo KANG, Ansan-si (KR); Dong Won PARK, Cheonan-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/769,277

(22) Filed: Jun. 27, 2007

(30) Foreign Application Priority Data
Jun. 27, 2006 (KR) 10-2006-0058086

(51) Int. Cl. G09G 3/36

(52) U.S. Cl. 345/92

(57) ABSTRACT

A liquid crystal display (“LCD”) device includes a liquid crystal panel for displaying images, a backlight unit for supplying light to the liquid crystal panel, an operation unit for generating an operation value by performing operations on pixel data supplied to the liquid crystal panel during at least one frame, a comparator which compares the operation value with a reference value and which generates a dimming signal having a high voltage level when the operation value is greater than the reference value, and which generates a dimming signal having a low level when the operation value is less than the reference value, and an inverter which drives the backlight unit according to the dimming signal.

This application claims priority to Korean Patent application No. 10-2006-0058086, filed on Jun. 27, 2006, and all the benefits accruing therefrom under 35 U.S.C. §119, the contents of which in its entirety are herein incorporated by reference.

### BACKGROUND OF THE INVENTION

1. Field of the Invention

The present invention relates to a liquid crystal display device and a driving method thereof, and more particularly, to a liquid crystal display device and a driving method thereof capable of improving display quality.

2. Description of the Related Art

Generally, liquid crystal display (“LCD”) devices have been widely applied to televisions, computer monitors, portable terminals, etc. owing to their lightness, thinness, and low power consumption.

The LCD device cannot emit light by itself, and therefore it needs a backlight unit to provide light thereto. Typically, the backlight unit uses a cold cathode fluorescent lamp (“CCFL”) or an external electrode fluorescent lamp (“EEFL”) to provide that light. The CCFL or EEFL is a luminous element using a phenomenon caused by electron emission and has the advantage of low heat emission, high luminescence, and long life. A single lamp or a plurality of lamps is formed to supply light at the side or the back of the LCD device according to the needs of the LCD device.

The liquid crystal display includes a liquid crystal panel which modifies the transmittance of light therethrough. The liquid crystal panel may contain a plurality of pixels. Each pixel of the liquid crystal panel may allow most or all of the light from the backlight to pass therethrough in order to generate a full white pixel; conversely each pixel may prevent most or all of the light from the backlight from passing therethrough in order to generate a full black pixel. Alternatively, each pixel may allow only a fraction of the light to pass therethrough thereby generating a gray pixel.

The lamp is driven by an inverter supplying an alternating current (“AC”) power. Recently, an inverter dimming control method has been used for varying the luminance of the lamp by controlling the AC power supplied to the lamp from the inverter. In order to supply AC power from the inverter to the lamp, the timing controller supplies a pulse width modulation (“PWM”) dimming signal to the inverter and the inverter supplies a tube current corresponding to a duty ratio of the PWM dimming signal to the backlight unit. The inverter controls the tube current according to the PWM dimming signal to drive the backlight unit with luminance corresponding to the dimming signal. In the above-described dimming control method, since the timing controller generates the PWM dimming signal according to the duty ratio and supplies the PWM dimming signal to the inverter, its internal load is increased.

As illustrated in FIGS. 1A and 1B a liquid crystal display may have a plurality of pixels, each pixel represented here by a different square. Each pixel may be independently driven to transmit differing amounts of light therethrough. However, no LCD panel is capable of entirely blocking all of the light from being transmitted therethrough, therefore when the luminosity of the backlight is especially intense light may pass through pixels which are meant to be opaque. This creates a washed-out effect where dark blacks are instead displayed as a shade of gray; this effect is shown in FIG. 1A. Alternatively, if the luminosity of the backlight is decreased so that black pixels remain opaque the brightness of pixels which are meant to transmit all or most of the light therethrough, e.g., white pixels, is diminished as well as shown in FIG. 1B. The dimming signal is sent to the inverter in order to control the luminance of the backlight unit in order to prevent image degradation associated with either too strong or too weak a backlight.

Furthermore, since the PWM dimming signal having a duty ratio is a high frequency AC signal, electromagnetic interference (“EMI”) or wave pattern interference occurs due to frequency components when the PWM dimming signal is transferred from the timing controller to the inverter, thereby lowering display quality. In addition, if the duty ratio of the PWM dimming signal from the timing controller is changed or if the frequency of the PWM dimming signal is changed, an unwanted flicker occurs.

### BRIEF SUMMARY OF THE INVENTION

It is therefore an aspect of the present invention to provide a liquid crystal display (“LCD”) device which improves display quality by controlling an inverter with a dimming signal having high and low levels, wherein the dimming signal is generated from a timing controller and controlling the luminance of a backlight unit with two luminance settings, and a driving method thereof.

In accordance with an aspect of the present invention, there is provided an exemplary embodiment of an LCD device, including a liquid crystal panel, a backlight unit which supplies light to the liquid crystal panel, an operation unit which generates an operation value by performing operations on pixel data supplied to the liquid crystal panel during at least one frame, a comparator which compares the operation value with a reference value, and which generates a dimming signal having a high level when the operation value is greater than the reference value, and which generates a dimming signal having a low level when the operation value is less than the reference value, and an inverter which drives the backlight unit according to the dimming signal.

The exemplary embodiment of an LCD device further includes a gate driving circuit which drives gate lines of the liquid crystal panel, a data driving circuit which drives data lines of the liquid crystal panel, a timing controller which supplies a first control signal to the gate driving circuit and which supplies a second control signal and pixel data to the data driving circuit, and a power supply which supplies power to the inverter.

An exemplary embodiment of the timing controller includes the operation unit and the comparator therein.

An exemplary embodiment of the operation unit adds pixel data during at least one frame.

The LCD device further comprises a memory which stores the pixel data during at least one frame.

An exemplary embodiment of the inverter supplies a first driving voltage to the backlight unit when a high level dimming signal is input thereto, and supply a second driving voltage to the backlight unit when the dimming signal of a low level is input thereto.

According to one exemplary embodiment the first driving voltage is a maximum output voltage of the inverter and the second driving voltage is a minimum output voltage of the inverter.

According to one exemplary embodiment if the maximum output voltage is supplied from the inverter, the backlight unit is driven with maximum luminance, and if the minimum output voltage is supplied from the inverter, the backlight unit is driven with minimum luminance.

In one exemplary embodiment the reference value is equal to or less than about 15% of a maximum value of the operation value.

In accordance with another exemplary embodiment of the present invention, there is provided an exemplary embodiment of a method of driving an LCD device. The method includes generating an operation value by performing operations on pixel data of at least one frame, comparing the operation value with a reference value, generating a dimming signal having a high level when the operation value is greater than the reference value, generating a dimming signal having a low level when the operation value is less than the reference value, generating a driving signal according to the dimming signal, and supplying the driving signal to a backlight unit.

According to one exemplary embodiment the generation of the driving signal includes generating a first driving voltage if the dimming signal having a high level is supplied to an inverter, and generating a second driving voltage if the dimming signal having a low level is supplied to the inverter.

According to one exemplary embodiment the method further includes driving the backlight unit to maximum luminance if the first driving voltage is supplied, and driving the backlight unit to minimum luminance if the second driving voltage is supplied.

According to one exemplary embodiment, the generating an operation value includes sampling the pixel data during at least one frame, adding the sampling pixel data, and outputting the sum of the sampling data as the operation value.

### BRIEF DESCRIPTION OF THE DRAWINGS

The above and other aspects, features and advantages of the present invention will become more apparent from the following detailed description when taken in conjunction with the accompanying drawings in which:

FIGS. 1A and 1B are diagrams schematically illustrating color display defects according to a dimming rate when displaying medium gray in a conventional liquid crystal display (“LCD”) device;

FIG. 2 is a block diagram schematically illustrating an exemplary embodiment of an LCD device according to the present invention;

FIG. 3 is a block diagram schematically illustrating an exemplary embodiment of a timing controller of the exemplary embodiment of an LCD device illustrated in FIG. 2;

FIG. 4 is a waveform chart illustrating an exemplary embodiment of a dimming signal generated from the exemplary embodiment of a timing controller illustrated in FIG. 3; and

FIG. 5 is a flow chart illustrating an exemplary embodiment of a driving method of the exemplary embodiment of an LCD device according to the present invention.

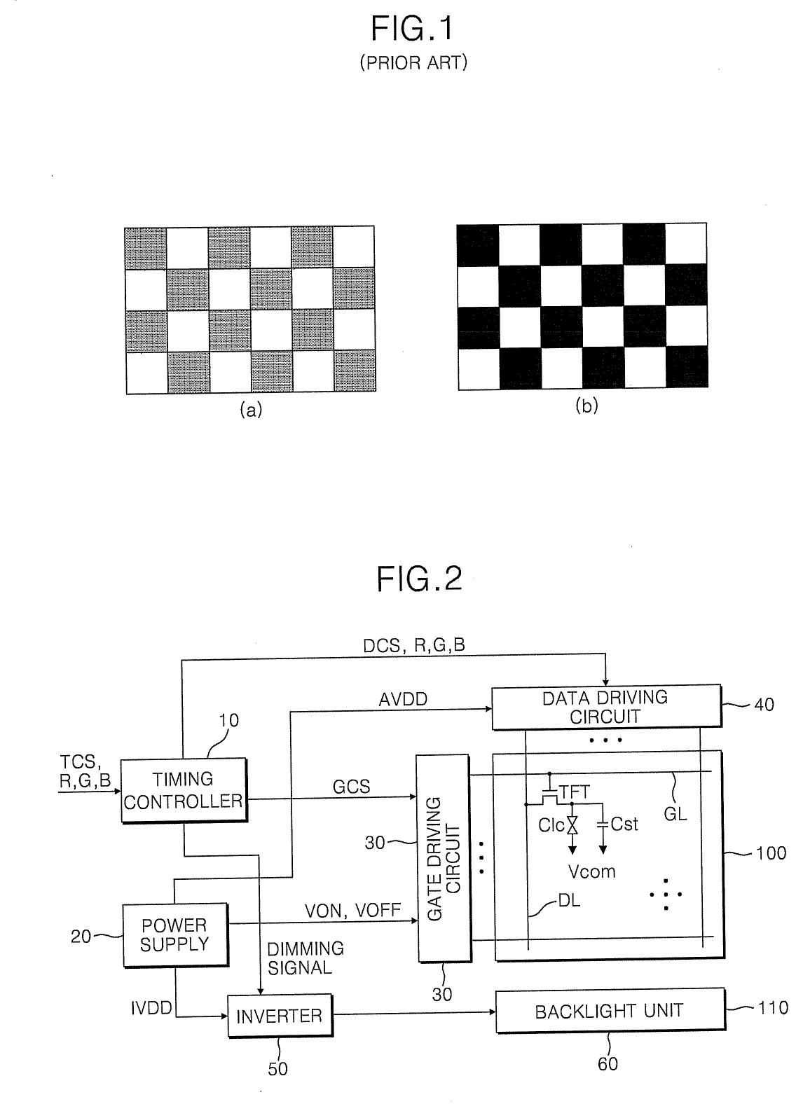

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

The exemplary embodiments of the present invention will now be described with reference to FIGS. 2 to 5.

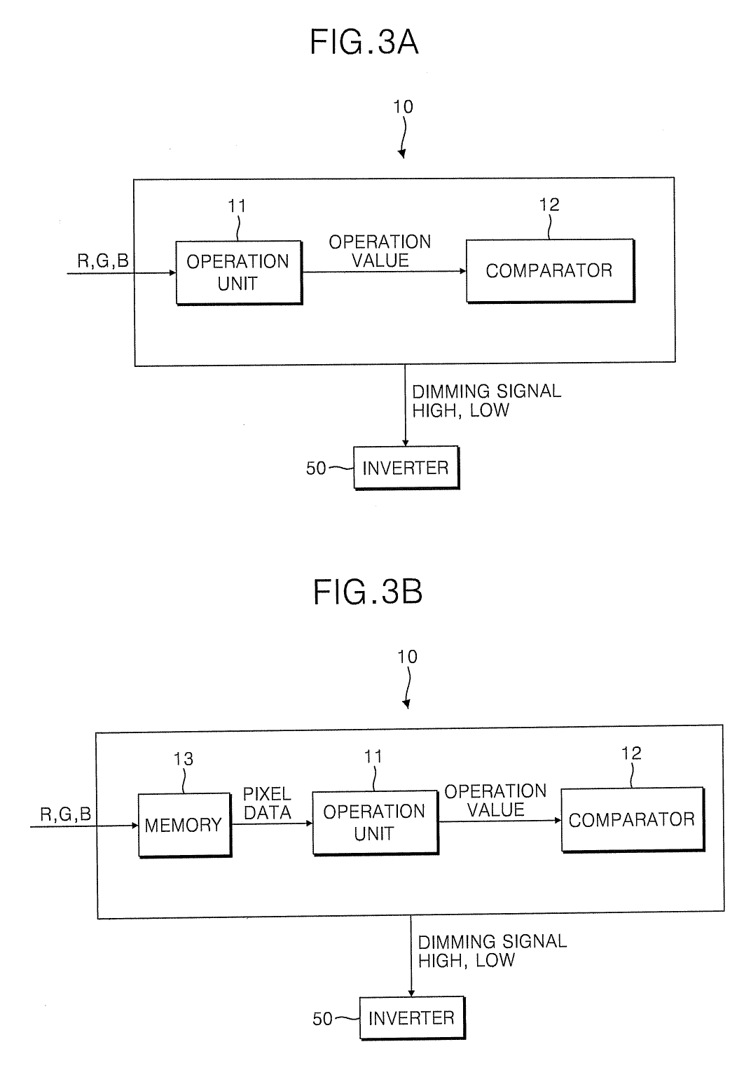

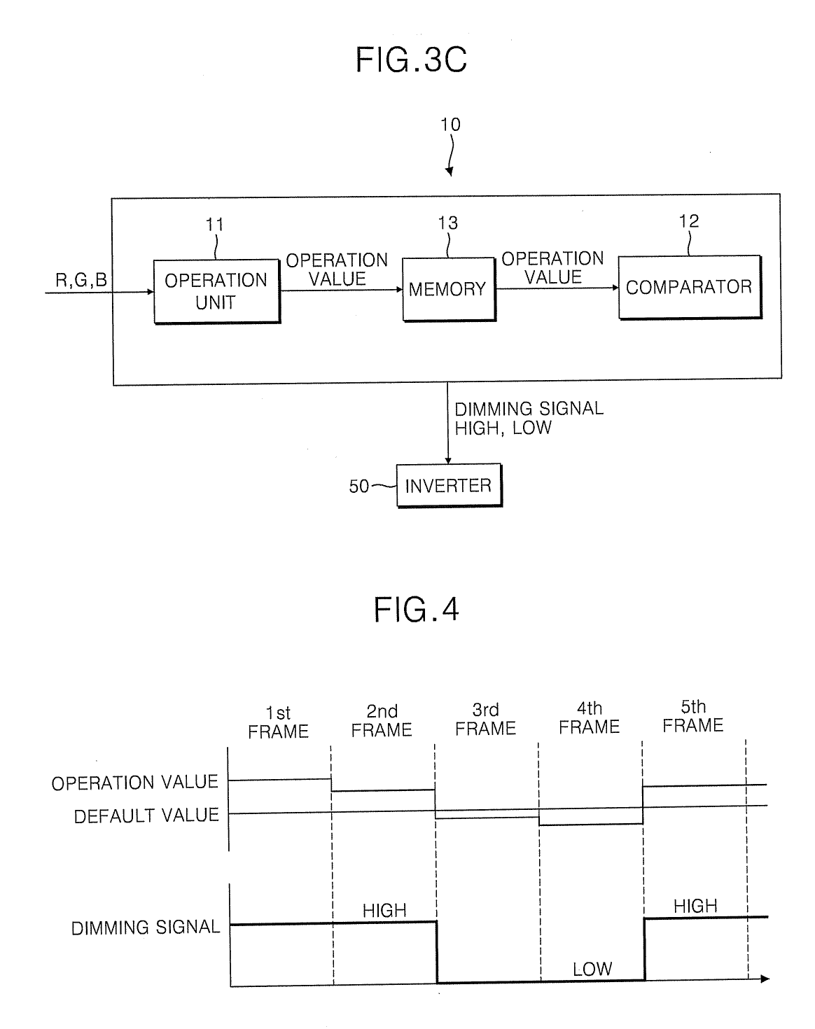

FIG. 2 is a block diagram schematically illustrating an exemplary embodiment of a liquid crystal display (“LCD”) device according to the present invention. FIG. 3 is a block diagram schematically illustrating an exemplary embodiment of a timing controller of the exemplary embodiment of an LCD device illustrated in FIG. 2.

Referring to FIGS. 2 and 3, the exemplary embodiment of an LCD device according to the present invention includes a liquid crystal panel 100 for displaying images, a backlight unit 60 for supplying light to the liquid crystal panel 100, a timing controller 10 which includes an operation unit 11 which generates an operation value by performing operations on pixel data supplied to the liquid crystal panel 100 from an outside source (not shown) during at least one frame and a comparator 12 for generating a dimming signal by comparing the operation value with a reference value, and an inverter 50 for driving the backlight unit 60 according to the dimming signal. The LCD device also includes a gate driving circuit 30 for driving gate lines of the liquid crystal panel 100, a data driving circuit 40 for driving data lines of the liquid crystal panel 100, a power supply 20 for supplying power to the inverter 50, the gate driving circuit 30 and the data driving circuit 40. The timing controller 10, including the operation unit 11 and the comparator 12, supplies a gate control signal GCS to the gate driving circuit 30 and supplies a data control signal DCS and pixel data to the data driving circuit 40.

The liquid crystal panel 100 includes a color filter substrate and a thin film transistor (“TFT”) substrate which are sealed with liquid crystals disposed therebetween.

The liquid crystals adjust the transmittance of light by rotating according to a voltage difference between a common voltage Vcom from a common electrode of the color filter substrate and a pixel voltage from a pixel electrode of the TFT substrate.

The color filter substrate includes a black matrix formed on an insulating substrate, exemplary embodiments of which include glass or plastic, to prevent light leakage, a color filter for displaying colors, the common electrode for supplying the common voltage Vcom to the liquid crystals, and a column spacer for maintaining a cell gap between the color filter and the TFT substrate.

Exemplary embodiments of the black matrix are formed of a black metal or organic material capable of cutting off light and preventing a light leakage current of a TFT. Exemplary embodiments of the color filter include red, green and blue color filters respectively having red, green and blue pigments transmitting or absorbing light of a specific wavelength. The LCD may display an image having a plurality of colors by additively mixing pixels having red, green and blue light generated by passing light from the backlight unit 60 respectively through the red, green and blue color filters. The common electrode is formed of a transparent conductive metal, exemplary embodiments of which include indium-tin-oxide (“ITO”) or indium-zinc-oxide (“IZO”), to supply the common voltage Vcom to the liquid crystals. Exemplary embodiments of the column spacer are formed of an organic material and maintain a cell gap, wherein a cell gap is the distance between the color filter substrate and the TFT substrate.

As shown in FIG. 2, the TFT substrate includes a TFT formed in a pixel area defined by an intersection of a gate line GL and a data line DL on an insulating substrate, exemplary embodiments of which include glass or plastic as mentioned above, and a pixel electrode and a storage electrode connected to the TFT.

The TFT is connected to the gate line GL and data line DL. The TFT has an input terminal connected to the data line DL, a gate terminal (also known as a control terminal) connected to the gate line and a pixel electrode (also known as the output terminal) connected to a storage capacitor Cst and a liquid crystal cell Clc. The TFT supplies a gray scale voltage from the data line DL to the pixel electrode in response to a gate ON voltage VON and a gate OFF voltage VOFF supplied from the gate line GL to the gate terminal of the TFT. The pixel electrode applies a pixel voltage to the liquid crystals using the gray scale voltage. The pixel electrode is formed of a transparent conductive material such as ITO or IZO so that it does not impede the passage of light when the liquid crystal layer is arranged to allow light to pass therethrough. The pixel electrode, the liquid crystals and the common electrode constitute a liquid crystal cell Clc. The storage electrode maintains the pixel voltage of the pixel electrode during one frame using the common voltage Vcom from a storage line connected thereto. An exemplary embodiment of a storage capacitor Cst is formed by disposing at least one insulating layer between the storage electrode and the pixel electrode.

Exemplary embodiments of the gate driving circuit 30 may be connected to the gate line GL by being mounted in a gate tape carrier package (“TCP”), or may be mounted by a chip-on-glass (“COG”) method on the TFT substrate. Alternative exemplary embodiments include configurations wherein the gate driving circuit 30 may be integrated on the TFT substrate. The gate driving circuit 30 sequentially supplies the gate ON voltage VON and gate OFF voltage VOFF to the gate line GL in response to the gate control signal GCS from the timing controller 10.

Exemplary embodiments of the data driving circuit 40 may be connected to the data line DL by being mounted in a data TCP, or may be mounted by a COG method on the TFT substrate. Alternative exemplary embodiments include configurations wherein the data driving circuit 4Q may be integrated on the TFT substrate. The data driving circuit 40 generates a gray scale voltage corresponding to digital image signals R, G and B from the timing controller 10 in response to the data control signal DCS from the timing controller 10. The data driving circuit 40 supplies the gray scale voltage to the data line DL whenever the gate ON voltage VON is supplied to the gate line GL in response to the data control signal DCS from the timing controller 10.

The power supply 20 boosts or lowers an externally supplied direct current (“DC”) voltage (not shown) and supplies the boosted or lowered voltage to the gate driving circuit 30, the data driving circuit 40 and the inverter 50. The power supply 20 supplies the gate ON and OFF voltages VON and VOFF to the gate driving circuit 30 and supplies an analog driving voltage AVDD to the data driving circuit 40. The power supply 20 also supplies an inverter driving voltage IVDD to the inverter 50 and supplies the common voltage Vcom to the liquid crystal panel 100 through the common electrode (not shown).

The timing controller 10 converts an externally supplied input control signal TCS and digital image signals R, G and B into digital image signals, R, G and B, the gate control signal GCS and the data control signal DCS. The timing controller 10 supplies the gate control signal GCS to the gate driving circuit 30 and supplies the digital image signals R, G and B and the data control signal DCS to the data driving circuit 40. One exemplary embodiment of the timing controller 10 includes a field programmable gate array (“FPGA”) consisting of regularly and repeatedly formed logic blocks. As illustrated in FIG. 3, the timing controller 10 includes the operation unit 11 which generates an operation value by performing operations on the digital image signals R, G and B during one frame, and the comparator 12 which generates a dimming signal by comparing the operation value generated from the operation unit 11 with a reference value.

The operation unit 11 adds the pixel data of the externally supplied digital image signals R, G and B. The FPGA arranges and adds the pixel data during one frame and generates the operation value. In one exemplary embodiment the operation unit 11 adds all the pixel data during one frame. In an alternative exemplary embodiment, the operations unit 11 adds pixel data extracted by sampling. In either exemplary embodiment the operation unit 11 outputs the added value as the operation value. Since the operation value includes gray scale information of the pixel data, it is possible to know gray scale information of a corresponding frame. In another exemplary embodiment the timing controller 10 further includes a memory 13 for storing pixel data during at least one frame. In such an exemplary embodiment the memory 13 stores pixel data during at least one frame and supplies the stored value to the operation unit 11. Alternatively, the memory 13 stores the operation value added by the operation unit 11 and supplies the stored operation value to the comparator 12. With or without the memory 13, the timing controller 10 then instructs the backlight unit 60 to supply light corresponding to the gray scale information to the liquid crystal panel 100 using the operation value added by the operation unit 11.

The comparator 12 compares the operation value added by the operation unit 11 with the reference value and generates the dimming signal. Since the operation value includes gray scale information of a corresponding frame as described above, the dimming signal corresponding to the gray scale information can be generated by comparison with the reference value. The dimming signal is a DC voltage of a high or low level. In one exemplary embodiment if the operation value is above the reference value, the comparator 12 generates a high level dimming signal and if the operation value is below the reference value the comparator 12 generates a low level dimming signal. For example, when the operation value having a higher voltage than the reference value, such as when the operation value of pixel data is for image signals of a high or medium gray scale, is added and is input into the comparator 12, the comparator 12 then generates the dimming signal having a high voltage level. If the operation value output from the operation unit 11 is less than the reference value, that is, if the pixel data for image signals of a low gray scale are added and that combined pixel data is less than the reference value, and that operation value is input to the comparator 12, the comparator 12 then generates the dimming signal of a low voltage level. In one exemplary embodiment the reference value is equal to or less than 15% of a maximum value of the operation value of the pixel data. In other words, the reference value is equal to or less than about 15% of the operation value of combined pixel data of a maximum gray scale. The luminance of the backlight unit 60 can be controlled in real time by supplying the dimming signal to the inverter 50.

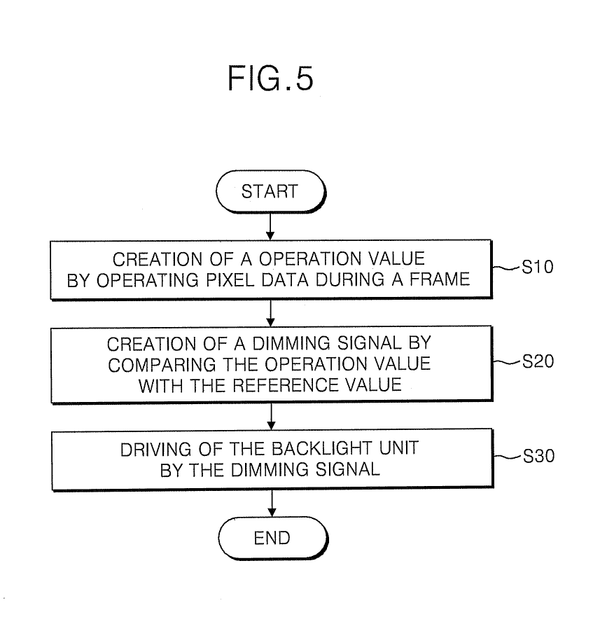

FIG. 4 is a waveform chart illustrating an exemplary embodiment of a dimming signal generated from the exemplary embodiment of a timing controller 10 illustrated in FIG. 3.

Referring to FIG. 4, if the operation value of pixel data of a first frame supplied to the timing controller 10 is above the reference value, the comparator 12 of the timing controller 10 generates the dimming signal of a high level. Although the operation value of pixel data of a second frame following the first frame is less than that of the first frame, since it is still greater than the reference value, the comparator 12 generates the dimming signal of a high voltage level. Next, in the third frame the operation value of pixel data is less than the reference value and the comparator 12 generates the dimming signal of a low voltage level. When the dimming signal of a high voltage level is supplied to the backlight unit 60 it will provide light with a high luminance to the LC panel, and when the dimming signal of a low voltage level is supplied to the backlight unit 50 it will provide light with a low luminance to the LC panel. In the example provided in FIG. 4 the backlight unit 60 will provide high luminance light to the LC panel in frames 1, 2 and 5 and it will supply low luminance light to the LC in frames 3 and 4.

The inverter 50 converts the inverter driving voltage IVDD provided from the power supply 20 into an AC driving voltage having a driving frequency corresponding to the dimming signal. The inverter 50 also boosts the AC driving voltage and supplies an AC tube current to the backlight unit 60, thereby driving the backlight unit 60. The inverter 50 converts the inverter driving voltage IVDD into a first and second driving voltage, each of them being an AC voltage, having a set driving frequency according to the dimming signal provided from the timing controller 10.

The first driving voltage is a boosted AC voltage according to the dimming signal of a high voltage level provided from the timing controller 10 and its AC tube current is supplied to the backlight unit 60. In one exemplary embodiment the first driving voltage has a voltage level equal to the maximum output of the inverter 50. Therefore, when supplied with the first driving voltage, the backlight unit 60 supplies light of high luminance to the LC panel.

The second driving voltage is an AC voltage which is boosted or not boosted according to the dimming signal of a low voltage level provided from the timing controller 10 and its AC tube current is supplied to the backlight unit 60. In one exemplary embodiment the second driving voltage has a voltage level equal to the minimum output of the inverter 50. Therefore, when supplied with the second driving voltage, the backlight unit supplies light of low luminance to the LC panel.

Exemplary embodiments of the backlight unit 60 may be formed of a single CCFL or EEFL, or a plurality of CCFLs or EEFLs. For example, if the size of the liquid crystal panel is small, a single lamp or a small number of lamps may be used, and for an LCD device such as a large-sized television, a plurality of lamps may be used. In one exemplary embodiment of the present invention wherein a plurality of lamps are used the lamps may be formed in parallel.

As described above, if the operation value of pixel data during each frame is above the reference value, the dimming signal having a high level is supplied to the inverter and the inverter supplies the backlight unit with a high voltage level dimming signal, which in turn increases the luminance of light supplied to the liquid crystal panel. If the operation value is less than the reference value, the dimming signal having a low voltage level is supplied to the inverter and the inverter supplies the backlight unit with a low voltage level dimming signal, which in turn decreases the luminance of light supplied to the liquid crystal panel. In such an exemplary embodiment of a method of driving a backlight unit a gray scale having a voltage level which is above a voltage of a reference gray scale has an improved luminance, and a gray scale having a voltage level which is lower than a voltage of a reference gray scale the display quality is improved by increasing sharpness of picture quality. Thereby a contrast ratio of the LCD device can be improved. In addition, since there is no need to generate a PWM dimming signal, a display defect caused by a wave pattern interference or electromagnetic interference (“EMI”) can be reduced or effectively prevented.

FIG. 5 is a flow chart illustrating an exemplary embodiment of a driving method of the exemplary embodiment of an LCD device according to the present invention.

Referring to FIG. 5, an exemplary embodiment of a driving method of the LCD device includes the steps of generating the operation value by performing operations on pixel data supplied to the liquid crystal panel during at least one frame (step S10), generating the dimming signal by comparing the operation value with the reference value (step S20), and generating the driving signal according to the dimming signal and supplying the driving signal to the backlight unit (step S30).

Specifically, in step S10, if the externally supplied digital image signals R, G and B are supplied to the timing controller 10, the operation unit 11 of the timing controller 10 generates the operation value by performing operations on pixel data during at least one frame. In one exemplary embodiment the operation unit 11 is a logic block of the FPGA installed in the timing controller 10. In one exemplary embodiment the operation unit 11 generates the operation value by adding the pixel data including the image information inputted during one frame. The operation value is then generated by adding all the pixel data during one frame or by sampling of pixel data and then adding the sampling pixel data during one frame. The generated operation value is supplied to the comparator 12.

In step S20 the comparator 12, which in one exemplary embodiment is another logic block of the FPGA installed in the timing controller 10, compares the operation value with the reference value to generate the dimming signal. The comparator 12 compares the reference value, one exemplary embodiment of which is a value equal to or less than 15% of the combined value of pixel data of a fully white gray scale, with the operation value provided from the operation unit 11. If the operation value is greater than the reference value, the comparator 12 generates the dimming signal of a high level and if the operation value is less than the reference value, it generates the dimming signal of a low level.

The inverter 50 generates the first or second driving voltage according to the dimming signal generated from the comparator 12. Specifically, in one exemplary embodiment, the inverter 50 generates any one of the first and second driving voltages having a constant frequency according to the dimming signal having a high or low level using the inverter driving voltage IVDD supplied from either the power supply 20 or an external source (not shown), and supplies the first or second driving voltage to the backlight unit 60. For instance, if the dimming signal having a high voltage level is supplied to the inverter 50, the inverter 50 generates the first driving voltage. In one exemplary embodiment the first driving voltage is a maximum output voltage of the inverter 50 and the inverter 50 supplies a maximum tube current to the backlight unit 60. When supplied with the maximum tube current, then the backlight unit 60 supplies light of high luminance to the liquid crystal panel 100. Meanwhile, if the dimming signal having a low voltage level is supplied to the inverter 50, the inverter 50 generates the second driving voltage. In one exemplary embodiment the second driving voltage is a minimum output voltage of the inverter 50 and the inverter 50 supplies a minimum tube current to the backlight unit 60. When supplied with the minimum tube current, the backlight unit 60 supplies light of low luminance to the liquid crystal panel 100. Therefore, the luminance of light output from the backlight unit 60 varies according to gray scale information of a frame unit, thereby improving a contrast ratio thereof.

As described above, the LCD device and driving method thereof according to the present invention can improve a contrast ratio because the operation unit can generate the operation value by performing operations on pixel data on a frame-by-frame basis and the comparator can compare the operation value with the reference value and generate the dimming signal for controlling the luminance of light during each frame.

Furthermore, since a PWM dimming signal is not used, a wave pattern interference or EMI caused by a high frequency component of the PWM dimming signal is substantially prevented, thereby improving display quality.

Moreover, since the PWM dimming signal is not used, the timing controller does not become overloaded due to the PWM dimming signal and therefore a malfunction of the LCD device can be prevented.

While the present invention has been shown and described with reference to exemplary embodiments thereof, it will be understood by those skilled in the art that various changes in form and details may be made therein without departing from the spirit and scope of the invention as defined by the appended claims.

What is claimed is:

1. A liquid crystal display device, comprising:
a liquid crystal panel which displays images;
a backlight unit which supplies light to the liquid crystal panel;
an operation unit which generates an operation value by performing operations on pixel data supplied to the liquid crystal panel during at least one frame;
a comparator which compares the operation value with a reference value, and which generates a dimming signal having a high level when the operation value is greater than the reference value, and which generates a dimming signal having a low level when the operation value is less than the reference value; and
an inverter which drives the backlight unit according to the dimming signal.

2. The liquid crystal display device of claim 1, further comprising:
a gate driving circuit which drives gate lines of the liquid crystal panel;
a data driving circuit which drives data lines of the liquid crystal panel;
a timing controller which supplies a first control signal to the gate driving circuit and which supplies a second control signal and pixel data to the data driving circuit; and
a power supply which supplies power to the inverter.

3. The liquid crystal display device of claim 2, wherein the timing controller includes the operation unit and the comparator therein.

4. The liquid crystal display device of claim 3, wherein the operation unit generates the operation value by adding pixel data during at least one frame.

5. The liquid crystal display device of claim 4, further comprising a memory which stores the pixel data during at least one frame.

6. The liquid crystal display device of claim 4, further comprising a memory which stores the operation value.

7. The liquid crystal display device of claim 5, wherein the inverter supplies a first driving voltage to the backlight unit when a high level dimming signal is input thereto, and the inverter supplies a second driving voltage to the backlight unit when a low level dimming signal is input thereto.

8. The liquid crystal display device of claim 7, wherein the first driving voltage is a maximum output voltage of the inverter and the second driving voltage is a minimum output voltage of the inverter.

9. The liquid crystal display device of claim 8, wherein if the maximum output voltage is supplied from the inverter, the backlight unit is driven with maximum luminance, and if the minimum output voltage is supplied from the inverter, the backlight unit is driven with minimum luminance.

10. The liquid crystal display device of claim 4, wherein the reference value is equal to or less than about 15% of a maximum value of the operation value.

11. A method of driving a liquid crystal display device, the method comprising:
generating an operation value by performing operations on pixel data of at least one frame;
comparing the operation value with a reference value;
generating a dimming signal having a high level when the operation value is greater than the reference value;
generating a dimming signal having a low level when the operation value is less than the reference value;
generating a driving signal according to the dimming signal; and
supplying the driving signal to a backlight unit.

12. The method of claim 11, wherein the generation of the driving signal comprises:
generating a first driving voltage if the dimming signal having a high level is supplied to an inverter; and
generating a second driving voltage if the dimming signal having a low level is supplied to the inverter.

13. The method of claim 12, further comprising driving the backlight unit to maximum luminance if the first driving voltage is supplied, and driving the backlight unit to minimum luminance if the second driving voltage is supplied.

14. The method of claim 11, wherein the generating an operation value comprises sampling the pixel data during at least one frame;
adding the sampling pixel data; and
outputting the sum of the sampling data as the operation value.
